(19) United States
(12) Patent Application Publication
(10) Pub. No.: US 2008/0295919 A1
(43) Pub. Date: Dec. 4, 2008

(54) Log splitter with pressure adjustment

(76) Inventor: Ernst Pfaff, Ichenhausen (DE)

Correspondence Address: BACON & THOMAS, PLLC, 625 SLATERS LANE, FOURTH FLOOR, ALEXANDRIA, VA, 22314-1176, US

(21) Appl. No.: 12/155,037

(22) Filed: May 29, 2008

(30) Foreign Application Priority Data
May 30, 2007 (DE) 10 2007 025 281.3

(51) Int. Cl. B27L 7/00

(52) U.S. Cl. 144/195.1

(57) ABSTRACT

A log splitter is being proposed for splitting a piece of wood into individual logs, with a platform for the piece of wood that is delineated on the axial sides by two stops (4, 5), which are each fitted in the normal direction to the axis of the wood to a holding part (1, 7), whereby at least one stop (5) is hydraulically operable in the axial direction and at least one stop (5) is designed as a splitting wedge.

The log splitter is characterized in that a valve (2) is designed in the pressure-sided hydraulic intake cable, with which the oil pressure that drives the movable stop (5) is adjustable, with which at least one stop is movable.

The invention relates to a log splitter according to the preamble of claim 1.

This type of log splitters is used in professional or hobby work to cut pieces of wood—that is, approved-length branches—into individual logs that may be used to fuel ovens or other similar purposes. A platform is set up for the piece of wood, which is limited through two stops, of which one can be hydraulically run and at least one is designed as a splitting wedge or is set up with a splitting wedge insert. The splitting wedge or splitting wedge insert is then pushed against the axial side of the piece of wood hydraulically. The wood is thus split into individual logs.

This type of log splitter could be a horizontal log splitter, in which the wood to be cut rests on a table, which delineates the platform from below. This type of log splitter can be seen under the German invention registration DE 10 2006 014 173. Other log splitters of this type have a vertical construction, in which the piece of wood is placed on a table on its axial side, which at the same time forms one of the two stops. This type of log splitter can be seen under the German invention registration DE 10 2006 032 054.

Based on the above, the following task arises: to further develop an appropriate-class log splitter, so it is possible to make the operation more efficient, easier on the materials and equipment, and safer.

This task is solved with the characteristics of claim 1.

Pursuant to the invention, a valve is designed in the pressure-sided hydraulic intake cable of the log splitter, with which the action of the movable stop or stops oil pressure is adjustable.

In this way, the oil pressure can be reduced; for example, when an easily cut wood or branches of smaller thickness or length need to be cut. In these cases, there is less wear on the splitting wedge and the other moving parts of the log splitter, and less energy is consumed. At the same time, there is an increase in user safety; the variable pressure ensures that excessive speed is not used on relatively soft or quickly split wood, which could lead to pieces of wood being thrown through the air and possibly striking the operator.

Otherwise, in the case of hard-to-cut wood, or with an increase in the thickness or length of the wood, the pressure can be adjusted to the maximum hydraulically-supplied oil pressure, in order to be able to split reliably.

Further advantageous developments are the object of the sub-claims.

Thus, for example, a manual controlling mechanism is designed for adjustment of the valve. This is shown in one embodiment as a lever, in particular a hand-operated lever, which works together with the valve; for example, a pivot lever. A push level is also conceivable, however, which converts a pushing movement into a rotation—with an adjustment screw, for example—on the valve. In an alternative or expanded embodiment, the manual controlling mechanism could have a turning actuator, which works together with the valve. In this scenario, the turning actuator could, for example, work with the valve via a gear box. Here, a spindle or shaft could advantageously be a part of the gear, which could be moved translatively or spirally via a cog that is bound, torque-proof, to the turning actuator. The spindle itself would work together with the adjustment screw of the valve, or the shaft could be bound fast to the valve's piston.

Other connections from the manual controlling mechanism to an adjustment element in the valve for the adjustment of the cross-sectional area of an oil-flow space in the pressure-sided hydraulic intake cable would be conceivable. Here, the oil pressure would ultimately be controlled by way of the adjustment valve, and advantageously by way of the manual controlling mechanism. Moving adjustment elements for this would be, for example, a valve adjustment screw, with which a die diameter—or, as the case may be, a gas screw with a carburetor—would be adjustable, or a piston valve, which opens a specific cross-sectional area according to the setting; for example, a piston ring that is adjustable in its cross section.

It is furthermore advantageous when a gauge assembly is designed in the log splitter, on which the set oil level is visible. This would make it clear to the operator, which oil pressure they are currently splitting with. Particularly advantageous here would be a main scale, for a general reading of the oil pressure, as well as a further, finer scale, on which a more precise reading is possible. For many usage scenarios, it is enough to adjust the oil pressure approximately. If a more exact adjustment is required, the fine scale enables an exact reading of the oil pressure. A reading of the total oil pressure can be taken with high accuracy especially when the fine scale functions as a kind of vernier scale together with the main scale.

The individual characteristics of the embodiment pursuant to the claims lend themselves, insofar as it is reasonable, to be combined in any order. It is understood that the above-named, as well as the below characteristics are usable not only in the given combination, but also in other combinations or in isolation, without leaving the context of the invention.

In the following pages, the preferred embodiments of the invention are explained in more precise detail by means of schematic diagrams. They show:

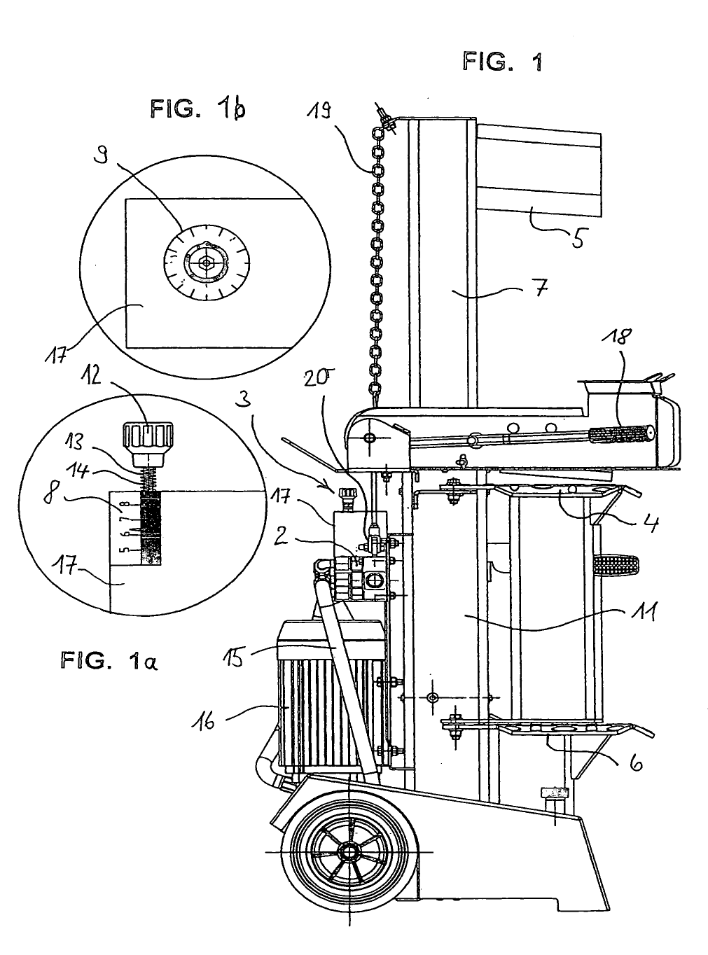

FIG. 1 a lateral view of the log splitter according to a first embodiment of the invention;

FIG. 1a A detail of the log splitter shown in FIG. 1;

FIG. 1b A further detail of the log splitter shown in FIG. 1;

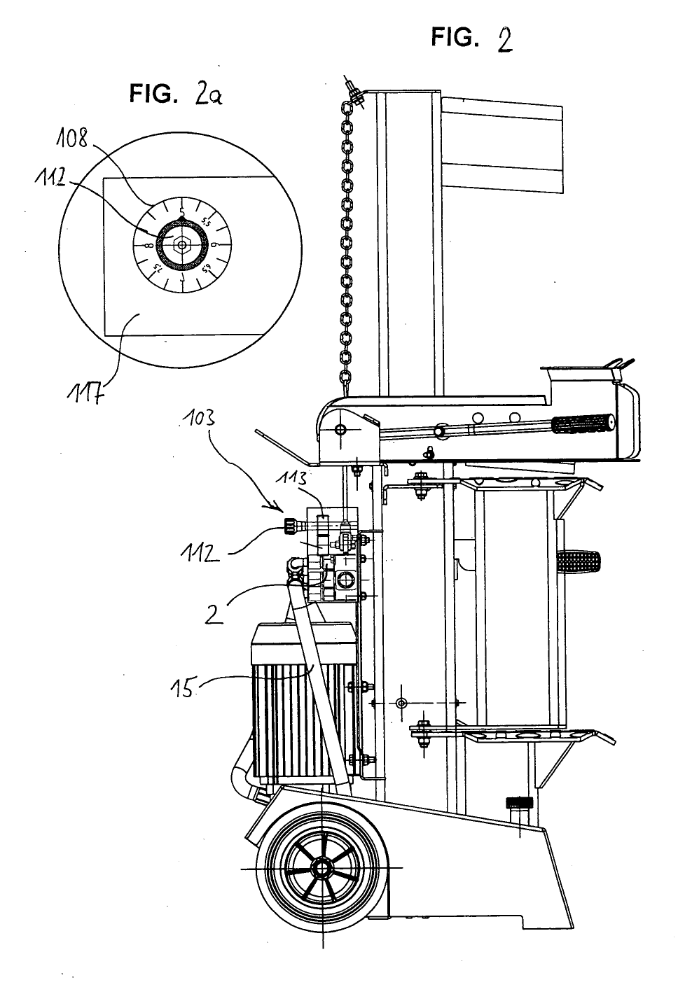

FIG. 2 A lateral view of a further embodiment of the log splitter according to the invention;

FIG. 2a A detail of the log splitter shown in FIG. 2;

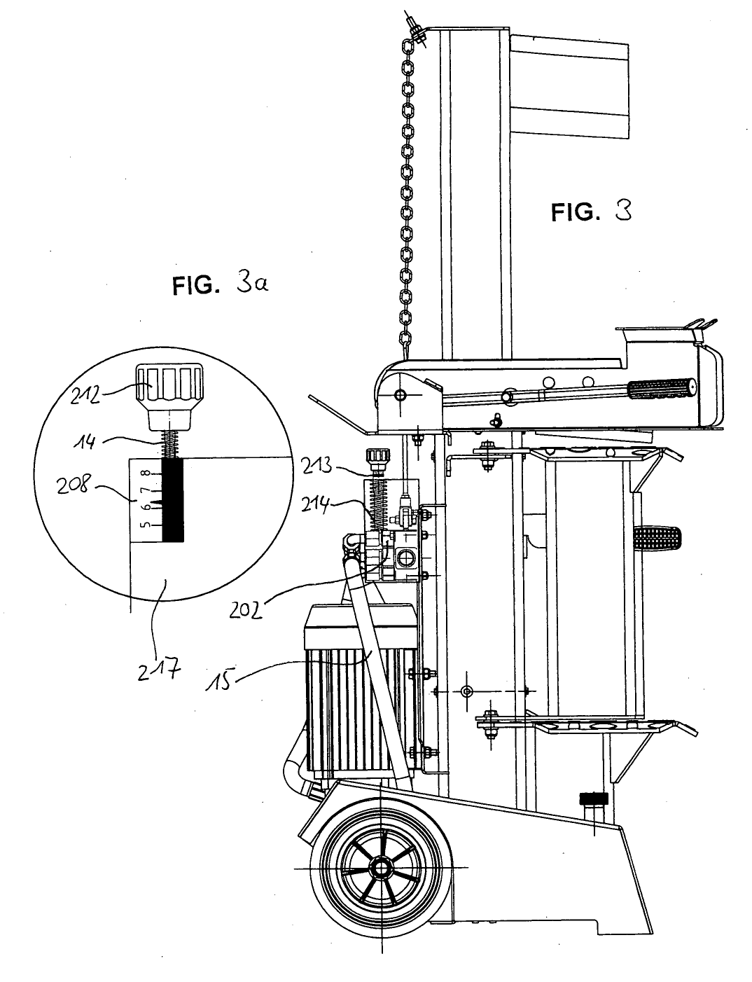

FIG. 3 A lateral view of a further embodiment of the log splitter according to the invention;

FIG. 3a A detail of the log splitter shown in FIG. 3.

First the principle construction of a class-appropriate log splitter will be explained with reference to FIG. 1.

The log splitter here is designed as a vertical log splitter, on which a lower table 6 is designed, on which a piece of wood can be placed. Above this, another table 4 is designed, on which shorter pieces of wood can be placed. The table 4 is designed as a removable table, so that it can be removed when longer pieces or wood are to be cut on table 6. Both tables, 4 or 6, are fixed to a pillar 11, and protrude at a right angle to the axis of the piece of wood, so the wood to be cut can be placed on one of the tables on its axial side. In pillar 11, a beam 7 is incorporated vertically or along the axis of the piece of wood, and can be moved. A splitting wedge 5 is fixed to this beam; the splitting wedge serves as a counter stop for the table 4 or 6 being used during splitting. Here, the beam 7 is operable via a hydraulic piston valve; for example, a compressor 16 is designed on the log splitter, which supplies the piston valve via a hydraulic intake cable 15 and a valve block 17 with oil or another type of hydraulic fluid, so that the splitting wedge 5 can be moved up and down.

For example, an appropriate tulip-shaped splitting wedge insert can also be designed on the splitting wedge 5. In the example, a two-hand operated lever assembly 18 is designed for the operation of the drive mechanism, with which the hydraulic operation can be moved in the desired direction. Furthermore, a chain 19, bound to the shutoff valve 20, is designed for the shutdown of the hydraulic mechanism upon reaching the upper-end position through the splitting wedge 5 or the beam 7.

Here, the valve block 17 exhibits multiple intake valves for the piston assembly, with which the splitting wedge mechanism of the log splitter is driven. One of the intake valves here is marked with 2 and has an oil-flow space, adjusted through a manual mechanism, designated with 3.

The manual adjustment mechanism 3 or the manual controlling mechanism 3 comprises here a hand grip 12 (cf. FIG. 1a) on a pivot lever 13. As shown in FIG. 1a, the pivot lever is pre-loaded via a spring 14 out of contact with an adjustment element to alter the oil-flow space on valve 2. When the pivot lever is first pushed towards the bottom in operation with the adjustment element and then deviated, the oil-flow space on valve 2 and thus the oil pressure in the piston valve assembly can be adjusted for the operation of the splitting wedge 5. Here, the adjustment element is designed in an appropriate manner; for example, the lever 13 can activate the piston valve of valve 2 as a kind of compensator, which lies across from the hand grip 12.

Furthermore, as shown in FIG. 1a, a scale is designed on the valve block 17, (in the example on the surface that is vertical to the sheet level), on which the current oil pressure is displayed. For this, the log splitter has a constructed oil pressure sensor, well known in the trade. The sensor's pressure values are displayed on the scale, which coverts them to be read from the calibrated scale markings. Here, a fine scale 9 is designed near scale 8, as shown in FIG. 1b, in the head of the hand grip 12. This fine scale displays decimal places of the pressure—shown as a rough value from 5 to 8 bar on the scale 8—between the two full numbers. As a result, a more exact reading of the pressure can be taken by looking at both the scale 8 and the fine scale 9 to the decimal place.

With this advantageous construction, an exact setting of the pressure in the hydraulic assembly can be achieved for the operation of the splitting wedge 5, so that it can be adjusted appropriately to the given splitting task. In this way, the lifetime of the log splitter as well as the sharpening and replacement intervals of the splitting wedge can be significantly increased. The safety during splitting is increased as well, since there is no reason to fear flying logs when the pressure is set exactly to the given splitting task.

A further embodiment of the invention-appropriate log splitter is shown in FIG. 2, whereby the principal construction of the log splitter is similar to the log splitter shown in FIG. 1. The only differences between this and the one shown in FIG. 1 are as follows: the controlling mechanism designed for the operation of the adjustment element of valve 2, designated here with 103; and the scale for reading the current pressure, designated here with 108 (cf. FIG. 2a).

The manual controlling mechanism 103 has here a rotating hand grip or turning actuator 112, which is bound, torque-proof, to a cog in the gear box 113 through a corresponding bolt. In the operation of the cog in the gear-box 113 via the turning actuator 112, an adjustment element (not shown) of valve 2 is activated (for example, a movable shaft-bound piston valve). whereby the oil-flow cross-sectional area, and with it the oil pressure, can be adjusted. For a scale, a round scale 108 is designed, which is shown in FIG. 2a. This is located near the rotary handle 112 on the valve block 117; this is different from the embodiment shown in FIG. 1. The oil pressure is shown on the round scale 108, calibrated in round sections. The scale also has intermittent values, i.e. half- and quarter-bar markings.

A further embodiment of the invention-appropriate log splitter is shown in FIG. 3 and 3a. Here again the construction is similar to the log splitters shown in the previous figures. The following are the only differences compared to the previously shown embodiments: the manual controlling mechanism 202, as the valve 202 that works with the controlling mechanism; and the pressure scale 208.

The manual controlling mechanism 203 has a rotary handle 212, which is fitted to a thread bolt 213. The thread bolt can be threaded in or out of the valve block 217 with the thread indicated with 214. At its end, the thread bolt is bound with a correcting bolt, which operates on the oil-flow cross-section in the valve 202 via a membrane, for example. In this way, the oil pressure in the piston valve is adjustable for the operation of the splitting wedge 5. To read the oil pressure, here there is only a rough-value scale 208, which corresponds to the rough scale 8 from FIG. 1a.

As a matter of course, deviations from the shown variants are possible, without abandoning the fundamental ideas of the invention.

In this way, any appropriate valve or nozzle construction would be conceivable for the adjustment of the oil pressure. For example, a magnet valve could also be designed, whereby the strength of the magnet would be adjusted through a manually operated mechanism. In this way, the gauge assembly and or the turning actuator or hand grip could also be integrated into the grip assembly 18 in a simple manner.

1. Log splitter for cleaving a piece of wood into individual logs with a platform for the piece of wood, which is delineated by two stops on the axial sides, which are each fitted in the normal direction to the axis of the wood to a holding part, whereby at least one stop is hydraulically operable in the axial direction and at least one stop is designed as a splitting wedge, characterized in that, in the pressure-sided hydraulic intake cable at least one valve is designed so that the oil pressure that drives the movable stop is adjustable.

2. Log splitter pursuant to claim 1, characterized in that a manually operable controlling mechanism is designed for the adjustment of the valve.

3. Log splitter pursuant to claim 2, characterized in that a gauge assembly is designed, from which the set oil pressure can be read.

4. Log splitter pursuant to claim 3, characterized in that along with a main scale for a general reading of the oil pressure, a fine scale for a fine reading of the oil pressure is designed.

5. Log splitter pursuant to claim 4, characterized in that the fine scale works as a kind of vernier scale together with the main scale.

6. Log splitter pursuant to claim 2, characterized in that the valve comprises an adjustment screw for the adjustment of the cross-sectional area of the oil-flow space in the pressure-sided hydraulic intake cable.

7. Log splitter pursuant to claim 2, characterized in that the valve comprises a piston valve for the adjustment of the cross-sectional area of the oil-flow space in the pressure-sided hydraulic intake cable.

8. Log splitter pursuant to claim 2, characterized in that the manually operable controlling mechanism works in coordination with the valve via a lever.

9. Log splitter pursuant to claim 8, characterized in that the lever is a pivot lever.

10. Log splitter pursuant to claim 8, characterized in that the lever is a push lever.

11. Log splitter pursuant to claim 2, characterized in that the manually operable controlling mechanism works in coordination with the valve via a gear box.

12. Log splitter pursuant to claim 2, characterized in that the hand-activated controlling mechanism comprises a turning actuator, which works in coordination with the valve.

13. Log splitter pursuant to claim 12, characterized in that the turning actuator is fixed to a threaded bolt, which can be threaded into and out of a borehole in a adjustment block.

14. Log splitter pursuant to claim 13, characterized in that the threaded bolt with the adjustment screw of the valve being able to be bound, torque-proof, or that the threaded bolt and the adjustment screw are one piece.

15. Log splitter pursuant to claim 12, characterized in that the turning actuator is bound, torque proof, with a cog of the gear box, which works together with a movable-position spindle. This is used to adjust the cross-sectional area of the oil-flow space.

16. Log splitter pursuant to claim 2, characterized in that at least one part of the manually operable controlling mechanism, is preloaded through a spring out of contact with the adjustment screw or the piston valve.
